(19) United States
(12) Patent Application Publication
(10) Pub. No.: US 2001/0025762 A1
(43) Pub. Date: Oct. 4, 2001

(54) Torsional vibration damper

(75) Inventors: Benedikt Schauder, Schweinfurt (DE); Bernhard Schierling, Kurnach (DE); Jurgen Kleifges, Schweinfurt (DE)

Correspondence Address: Thomas C. Pontani, Esq., Cohen, Pontani, Lieberman & Pavane, Suite 1210, 551 Fifth Avenue, New York, NY, 10176, US

(73) Assignee: Mannesmann Sachs AG

(21) Appl. No.: 09/774,848

(22) Filed: Jan. 31, 2001

(30) Foreign Application Priority Data
Jan. 31, 2000 (DE) 100 04 125.6

(51) Int. Cl. F16D 3/00; F16F 15/10

(52) U.S. Cl. 192/212; 464/68; 74/574

(57) ABSTRACT

A torsional vibration damper, particularly for a drivetrain in a motor vehicle, having a substantially disk-shaped flywheel mass element having a friction surface for cooperating with friction facings of a friction clutch and a damper element arrangement communicating with the flywheel mass element, wherein the flywheel mass element is produced from a sheet metal material.

### BACKGROUND OF THE INVENTION

1. Field of the Invention

The present invention is directed to a torsional vibration damper, particularly for a drivetrain in a motor vehicle, comprising a substantially disk-shaped flywheel mass element having a friction surface for cooperating with friction facings of a friction clutch and a damper element arrangement communicating with the flywheel mass element.

2. Description of the Related Art

A torsional vibration damper of the type mentioned above is known from U.S. Pat. No. 5,669,478. In this torsional vibration damper, the flywheel mass element is made from cast material. However, the following problems occur when such a material is selected: in certain operating situations, for example, when ascending a grade with a trailer, a very high rise in temperature can come about within a short time at the friction surface of the flywheel mass element, whereas the opposite side, i.e., the side of the flywheel mass element remote of the friction surface, is hardly heated. This results in a large heat gradient in axial direction inside the flywheel mass element which leads to very high internal stresses that can result in stress cracks or rupturing of the flywheel mass element. In order to prevent this, it is necessary to use high-quality cast materials which increases the cost of producing the flywheel mass element. Further, the construction of the flywheel mass element as a cast structural component part has the disadvantage that reworking or after-machining of the cast structural component part, for example, for arranging fastening bore holes, possibly threaded, or for forming cooling ribs on the back of the flywheel mass element remote of the friction surface, is very time-consuming and therefore costly.

### SUMMARY OF THE INVENTION

Therefore, it is the object of the invention to provide a torsional vibration damper of the type mentioned above in which the flywheel mass element is produced in a simple and economical manner so as to achieve greater stability with respect to temperature and rupture in operation.

This object is met by a torsional vibration damper of the type mentioned above in which the flywheel mass element is produced from a sheet metal material. A flywheel mass element that is produced from a sheet metal material, especially a deformable sheet metal material, has an appreciably greater resistance to temperature and rupture than a flywheel mass element produced from cast material due to the high elongation of the sheet metal material. Further, a sheet metal material can be given the desired shape economically due to its deformation behavior and can be machined in a substantially simpler manner than a cast material. Further, in order to maintain high strength, particularly surface strength, as may be required, for example, in the area of the friction surface of the flywheel mass element, a flywheel mass element produced from sheet metal material can be hardened in its entirety or only in some areas or can be provided with a hard coat, e.g., TiN.

In principle, any sheet metal material having a sufficient resistance to temperature and rupture can be considered for use as sheet metal material. For example, STW 24 or an aluminum sheet material can be selected as sheet metal material.

In a further development of the invention, the torsional vibration damper can have a transmission part which cooperates with the damper element arrangement and which is connected, via a connection area, with the flywheel mass element so as to be fixed with respect to rotation relative to it for common rotation about an axis of rotation of the torsional vibration damper. A construction of this type is advisable because the flywheel mass element can be constructed in a simple manner and the transmission part, which is loaded mechanically and thermally to a lesser extent, can be produced from a lower-grade material than the flywheel mass element.

In order to secure the transmission part and flywheel mass element in a reference position relative to one another in this type of construction, it can further be provided that the flywheel mass element has positioning means and that the transmission part has counter-positioning means which cooperate for positioning the flywheel mass element relative to the transmission part. In particular, a concentric rotational movement of the flywheel mass element and transmission part about the axis of rotation can be realized by means of this step.

The various possibilities for connecting the flywheel mass element produced from a sheet metal material with the transmission part coupled with the latter will be discussed at greater length in the following.

The flywheel mass element and the transmission part can be connected with one another in a positive engagement, for example. A positive engagement between the flywheel mass element and the transmission part is generally simple to produce and ensures a secure transmission of force from one part to the other.

The positive-engagement transmission can be realized in such a way, for example, that at least one bolt or rivet is formed integral with a part of the flywheel mass element and transmission part in the connection area and engages in a corresponding receiving opening in the other part of the flywheel mass element or transmission part. The bolt or rivet can be welded to the flywheel mass element beforehand or can be formed on the latter through a deformation or shaping process. The receiving opening in the other part can likewise be produced during the shaping process for this part, for example, by stamping.

In addition or alternatively, it can be provided for the positive engagement between the flywheel mass element and transmission part that a driving arrangement, preferably teeth, is formed integral with a part of the flywheel mass element and transmission part in the connection area and engages in a corresponding counter-driving arrangement, preferably complementing teeth, at the other part of the flywheel mass element or transmission part. A driving arrangement of this type can be formed, for example, by an individual plate which engages in a corresponding opening at the other part. For purposes of favorable, reliable force transmission behavior, it can be provided, in particular, that a toothing engaging with a corresponding counter-toothing is provided at one part of the flywheel mass element or transmission part.

For securing the flywheel mass element and transmission part axially, in addition to a driving arrangement at one part and a counter-driving arrangement at the other part, the flywheel mass element and the transmission part can be caulked together to be secured axially in the connection area. Accordingly, the flywheel mass element and the transmission part are first joined in the connection area and one part is then secured axially relative to the other part by caulking, preferably in the driving area or counter-driving area.

As an alternative to securing axially by caulking, that is, by means of an additional deformation process, it can be provided that the flywheel mass element and transmission part are secured with respect to one another by a retaining ring for securing axially in the connection area. Repairs, particularly exchanging the flywheel mass element, are facilitated by securing axially by means of a retaining ring; moreover, it is economical

According to the invention, another possibility for connecting the flywheel mass element and transmission part, in addition to the positive engagement described above, is that the flywheel mass element and transmission part can be connected with one another in the connection area in a frictional engagement. In this case, it is possible to position the flywheel mass element and transmission part at one another without the driving arrangement and counter-driving arrangement and to caulk the two parts together in an area provided for this purpose at one of the two parts, preferably in the area of the positioning means. Positioning plates extending from the transmission part in axial direction can be provided for this purpose, wherein the flywheel mass element is placed on these positioning plates and, in order to fasten the flywheel mass element to the transmission part, the positioning plates are then caulked at the end close to the flywheel mass element.

Alternatively or in addition to caulking the flywheel mass element and transmission part, it can be provided for connecting these two parts in a frictional engagement that a positioning step extending in circumferential direction is formed at the flywheel mass element and that a corresponding counter-positioning step extending in circumferential direction is formed at the transmission part, and that a part of the flywheel mass element and transmission part is shrink-fitted to the other part in the area of the positioning step and counter-positioning step. The connection of the flywheel mass element and transmission part by shrink fitting is especially simple in technical respects relating to manufacture because no additional steps such as caulking or the arrangement of fasteners, for example, are required. However, it is also possible to shrink one part on the other part and to provide a positive engagement in addition.

Further, the flywheel mass element and the transmission part can be connected with one another in a material engagement in the connection areas. This can be achieved, for example, by welding the flywheel mass element and transmission part, preferably by a laser welding process. Welding is selected, either by itself or in combination with a driving arrangement and a corresponding counter-driving arrangement, in particular when very high forces act between the transmission part and the flywheel mass element and are to be transmitted from one part to the other. The use of a laser welding process is therefore particularly suitable for producing the connection according to the invention because it ensures a precise production of the connection and high strength of the weld connection.

In a simple embodiment form of the material-engagement connection according to the invention, the flywheel mass element and the transmission part are glued together.

In addition or as an alternative to the connection possibilities described above, the flywheel mass element and the transmission part can be connected with one another in the connection area by at least one additional, separate connection element. The at least one separate connection element can be a screw or a rivet.

For purposes of fastening a thrust plate assembly, for increasing the stability and thermal strength of the flywheel mass element and/or for facilitating the arrangement of the flywheel mass element at the transmission part, various precautions which will be described in the following can be taken at the flywheel mass element which is produced from sheet metal material, according to the invention.

For example, a circumferential bend extending essentially orthogonal to the disk plane can be provided in the radial outer area of the flywheel mass element. A circumferential bend of this kind can be produced in a simple manner by a shaping process and can perform various tasks as will be shown in the following.

For example, at least one fastening opening extending in axial direction and preferably having an internal thread for fastening a thrust plate assembly of the friction clutch can be provided in the circumferential bend. The fastening opening can be provided by drilling or piercing.

Further, the circumferential bend can be constructed with two plies or layers, wherein the sheet metal material is bent in the radial outer area of the flywheel mass element essentially orthogonal to the disk plane of the flywheel mass element and is bent back in a vertex area of the circumferential bend in the direction of the disk plane, and wherein the at least one fastening opening is provided in the vertex area essentially in axial direction. A double-layered circumferential bend of this kind provides for a stable construction of the fastening opening in the radial outer area of the flywheel mass element, especially in a thin-walled flywheel mass element, so as to ensure a secure fastening of the thrust plate assembly to the flywheel mass element. If required, a clearance gap can be formed between the two layers, wherein the two layers can be welded together in the area of the gap opening for a further increase in strength.

Instead of using screws, the thrust plate assembly can also be formed at the flywheel mass element with a material engagement by welding, especially in the area of the circumferential bend, with a frictional engagement, for example, by shrinking a part of the flywheel mass element and housing of the thrust plate assembly onto the other part, or by clamping. In the latter case, the circumferential bend can be constructed so as to have at least two layers and a clamping gap which is accessible in axial direction can be formed between two layers, and the housing part of the thrust plate assembly can be securely clamped in the clamping gap. The clamping action is achieved in that the clearance gap between the two layers forming the clamping gap has a smaller gap width than the thickness of the structural component part of the thrust plate assembly to be fastened.

In order to position the structural component part of the thrust plate assembly to be arranged at the flywheel mass element, at least one positioning pin and/or fastening rivet can be provided in the radial outer area of the flywheel mass element. The fastening rivet or positioning pin can be formed integral with the flywheel mass element by means of a shaping process.

In order to improve the heat resistance of the flywheel mass element and to cool it in the area of the friction surface, it can be provided according to the invention that cooling slits extending from the radial inside to the radial outside are provided in the flywheel mass element in the area of the friction surface. These cooling slits are preferably very narrow considered in axial direction and preferably extend in a star-shaped manner from the radial inside to the radial outside. They enable a rapid removal of heat from the friction surface of the flywheel mass element, especially by air circulation.

To further increase the stability of the flywheel mass element, this flywheel mass element can be constructed so as to be stepped in its radial outer area. The step can extend in the direction of the thrust plate assembly and can overlap friction surfaces of the friction clutch in axial direction. As a further result of the stepped construction, the flywheel mass element has a greater dimensional stability than would be the case in the absence of the step, especially with intensive heating in the area of the friction surface, so that a sufficient frictional engagement between the friction surface of the flywheel mass element and the friction disk of the friction clutch adjacent to it is ensured in virtually every operating state, regardless of thermal deformation.

In order to achieve sufficient stability of the flywheel mass element, particularly in the case of a thin-walled sheet metal material which is easily deformable but less strong, it can further be provided according to the invention that the flywheel mass element comprises, at least in the area of the friction surface, at least two sheet metal parts which contact one another at least in some areas. The sheet metal parts can be connected with one another by a screw connection, rivet connection, glue connection or the like. Further, the sheet metal parts can be arranged at a distance from one another in the area of the friction surface for thermal decoupling and, therefore, to achieve a cooling effect.

As an alternative to a bending of the entire flywheel mass element in circumferential direction, mounting tongues can also be formed at the flywheel mass element for fitting the thrust plate assembly of the friction clutch and/or for arranging at the transmission part. The mounting tongues can be formed by free shaping (cutting out) individual sheet metal portions. Let it be determined, for example, with the friction surface of the flywheel mass element directed orthogonal to the axis of rotation, that the plane defining this friction surface is the disk plane; the mounting tongues can extend from this disk plane in the direction of the thrust plate assembly or in the direction of the transmission part.

With respect to the construction of the torsional vibration damper according to the invention, this torsional vibration damper can have a primary side which is connected or can be connected to a drive, and a secondary side which is rotatable about the axis of rotation against the action of the damper element arrangement, has the transmission part and the flywheel mass element fitted to the latter and is connected or can be connected to a driven unit, wherein the damper element arrangement has at least one spring unit which is arranged in the torque flow between the primary side and the secondary side. Also known as a two-mass flywheel, a torsional vibration damper of this kind with at least one spring unit as damper element can be constructed in a further development such that at least one planet wheel is arranged at one side, the primary side or secondary side, so as to be rotatable about another axis of rotation parallel to the first axis of rotation, wherein the at least one planet wheel has a planet wheel engagement configuration which engages with a counter-engagement configuration provided at the other side, the primary side or secondary side, for rotation of the at least one planet wheel about the other axis of rotation associated with it during relative rotation between the primary side and secondary side.

The damping behavior of the torsional vibration damper can be substantially improved by providing a planetary gear unit of this type leading to a rotation of the at least one planet wheel during relative rotation between the primary side and secondary side, especially when the at least one planet wheel moves in a viscous medium and rolls with its planet wheel engagement configuration against the resistance of the medium.

In a further development of the planetary gear unit, the at least one planet wheel can be mounted so as to be rotatable at a bearing area formed at the primary side and the counter-engagement configuration is formed at the transmission part.

As an alternative to a damper element arrangement formed with at least one spring unit, the torsional vibration damper according to the invention can be provided with a damper element arrangement which comprises a deflection mass arrangement with at least one deflection mass which is associated with a deflection path in which the at least one deflection mass can move about the axis of rotation during the rotation of the flywheel mass element. Damping of torsional vibrations is carried out in this type of construction of a damper element arrangement by the effect of the mass inertia of the at least one deflection mass which counteracts oscillatory movements of the torsional vibration damper and not, as in the present case, by compressing the at least one spring unit and, as the case may be, by fluid friction between the viscous medium and parts moving in the latter. This effect can be achieved in a simple construction in that the deflection path associated with the at least one deflection mass has a vertex area with the greatest radial distance from the axis of rotation and, proceeding from the vertex area, has deflection areas whose radial distance from the axis of rotation decreases with increasing distance from the vertex area. At a constant rate of rotation, the deflection mass swings into the vertex area of the deflection path and remains there substantially stationary relative to the deflection path, i.e., the at least one deflection mass moves at the same speed as the structural component part having the deflection path associated with the deflection mass. However, in case of variations in rotational speed (torsional vibrations), the deflection mass always moves opposite to the respective fluctuation in rotational speed due to its inertia, wherein it moves along the deflection path in opposition to the speed-dependent centrifugal force. In so doing, its radial distance form the axis of rotation decreases. The action of centrifugal force by which the at least one deflection mass is pressed onto the deflection path, provides for a counterforce to the change in speed during this movement, so that torsional vibrations can be damped.

An adequate response behavior of a damper element arrangement constructed with at least one deflection mass results in particular when the at least one deflection mass can move substantially freely on the deflection path. This can be achieved, according to the invention, in that the at least one deflection mass is received so as to be displaceable in a chamber associated with it, this chamber being defined at least partially by the flywheel mass element. A simple and economical construction results, for example, when the deflection path is formed at least partially at the flywheel mass element. The flywheel mass element and the at least one deflection path formed at the latter can be produced by a simple shaping process. A separate cover element which is preferably formed as a sheet metal part can be provided for closing the bearing chamber associated with the at least one deflection mass in a simple manner.

Preferred embodiment examples of the invention are described in the following with reference to the accompanying Figures.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

In the drawings:

FIG. 1 shows a torsional vibration damper according to the invention with a positive engagement between the flywheel mass element and the transmission part;

FIG. 2 shows a torsional vibration damper, likewise with positive engagement between the flywheel mass element and transmission part;

FIG. 3 shows another embodiment form of a torsional vibration damper according to the invention with positive engagement between the flywheel mass element and transmission part;

FIGS. 3a, 3b show enlarged views of the area designated by III in FIG. 3;

FIG. 4 shows a torsional vibration damper according to the invention with frictional engagement between the flywheel mass element and transmission part;

FIG. 5 shows a torsional vibration damper of another embodiment example with frictional engagement between the flywheel mass element and transmission part;

FIG. 6 shows a torsional vibration damper with material engagement between the flywheel mass element and transmission part;

FIG. 7 shows a torsional vibration damper of another embodiment example with material engagement between the flywheel mass element and transmission part;

FIG. 7a is a partial view of the torsional vibration damper from FIG. 7 viewed in the direction of arrow VII;

FIGS. 8, 9 show torsional vibration dampers in which the flywheel mass element and transmission part are connected by means of a separate connection element;

FIGS. 10a-10e show different constructions of the radial outer area of t the flywheel mass element;

FIGS. 11a-11c shows various possibilities for arranging a housing of a thrust plate assembly at the radial outer area of the flywheel mass element according to the invention;

FIG. 12 shows a torsional vibration damper according to the invention with deflection masses as damper element arrangement;

FIG. 13 is a perspective view of the torsional vibration damper shown in FIG. 12;

FIGS. 14 to 17 show torsional vibration dampers with deflection masses with additional constructions of the flywheel mass element according to the invention.

### DETAILED DESCRIPTION OF IHE PRESENTLY PREFERRED EMBODIMENTS

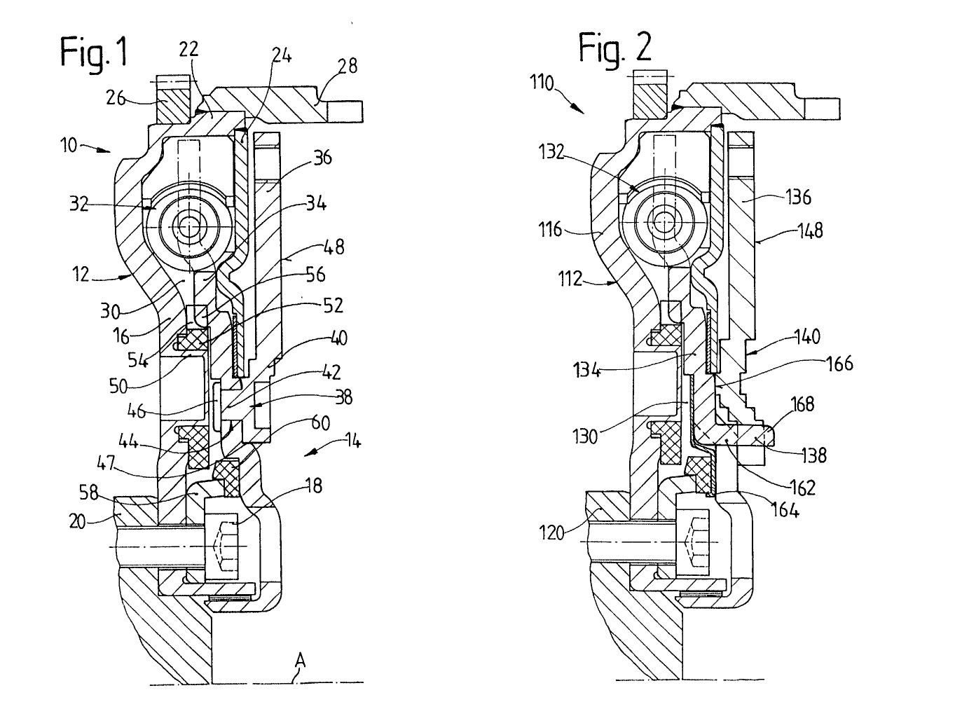

FIG. 1 shows a torsional vibration damper 10 according to the invention. This torsional vibration damper 10 comprises a primary side 12 and a secondary side 14 which are rotatable relative to one another about an axis of rotation A. The primary side 12 comprises a substantially disk-shaped first transmission part 16 which is arranged at a drive shaft 20 on the radial inner side by a plurality of fastening screws 18. On the radial outer side, the first transmission part 16 has an annular portion 22, extending substantially in axial direction, to which a disk element 24 which extends radially inward is connected by welding. Further, a starter ring gear 26 and an additional mass element 28 are arranged at the axial portion 22. The first transmission part 16 and the disk element 23 together form a hollow space 30 which is tightly closed toward the radial outer side and in which a damper element arrangement 32 which has at least one spring unit and which is filled with a viscous medium, e.g., lubricating grease, is positioned. Further, a second transmission part 34 which is fixedly connected with a flywheel mass element 36 in a connection area 38 projects from the radial inner side into the hollow space 30.

The connection area 38 comprises in particular a rivet 42 which is formed integral with the radial inner area 40 of the flywheel mass element 36 and which engages in a corresponding receiving opening 44 in the second transmission part 34 and is deformed at its side 46 remote of the flywheel mass element in order to secure the flywheel mass element 36. The flywheel mass element 36 is connected in a positive engagement with the transmission part 34 in that the rivet 42 engages in the corresponding receiving opening 44 and is deformed at its end 46. A positioning of the flywheel mass element 36 relative to the transmission part 34 is carried out via the radial inner area of the flywheel mass element 36 and a positioning step 47 which cooperates with this flywheel mass element 36 and is formed at the transmission part 34.

The flywheel mass element 36 is produced from a sheet metal material which, on the one hand, provides for sufficient strength of the flywheel mass element 36 but, on the other hand, facilitates shaping processes, e.g., in the radial inner area 40. As will be described more fully in the following, the flywheel mass element 36 comprises a friction surface 48 which engages with clutch disks of a friction clutch (not shown in FIG. 1) and can be made to engage with the latter.

Although this is not shown in the sectional view in FIG. 1, a plurality of rivets 42 which engage with corresponding receiving openings 44 can be provided in circumferential direction.

As will further be seen from FIG. 1, bearing bushes 50 on which planet wheels 52 are mounted so as to be rotatable are pressed into the first transmission part 16. The planet wheels 52 have an external toothing 54 which engages with a counter-toothing 56 at the second transmission part 34. By means of a relative rotation between the primary side 12 and secondary side 14, the planet wheels 52 are rotated on their respective bearing bushes 50, wherein the external toothing 54 rotates in the hollow space 30 filled with viscous medium accompanied by fluid friction.

Further, an angle ring 58 is fastened, via fastening screws 18, to the primary side 12 which is in frictional engagement via a friction element 60 with the second transmission part 34 and prevents relative rotation between the primary side 12 and secondary side 14 by means of the frictional action.

FIG. 2 shows another embodiment form of the torsional vibration damper according to the invention, wherein components identical to or having the same action as the components in FIG. 1 are designated in FIG. 2 by the same reference numbers increased by 100. The torsional vibration damper 110 according to FIG. 2 corresponds substantially to the torsional vibration damper 10 according to FIG. 1, so that only the differences between the two are discussed in the following. The differences consist in the construction of the flywheel mass element 136, particularly in its radial inner area 140, and in the construction of the connection area 138. A plurality of bearing tongues 162 which are directed away from the first transmission part 116 are formed out of the second transmission part 134 in axial direction. A cover plate 164 is required to prevent the escape of viscous medium from the hollow space 130 in the area of the formed bearing tongues. The flywheel mass element 136 is constructed with a plurality of steps in the radial inner area 140 and is in mutual contact with the transmission part 134 via a contact face 166. Further, the flywheel mass element 136 has recesses 138 in its radial inner area which correspond to the bearing tongues 162, so that the flywheel mass element 136 can engage with the bearing tongues 162 at the transmission part 134 in a tooth-like engagement. For purposes of axially securing the flywheel mass element 136 to the transmission part 134, the bearing tongues 162 are caulked on their end 168 remote of the primary side, so that the flywheel mass element 136 is pressed against the transmission part 134 by the caulked area. In a construction of this kind, torque can be transmitted from the drive shaft 120 via the primary side 112 to the transmission part 134 via the damper element arrangement 132, wherein the torque is reliably transmitted to the flywheel mass element 136 through the bearing tongues 162 which cooperate as teeth and through the corresponding recesses in the flywheel mass element 136. The torque can then be transmitted via the friction surface 148 and via the friction clutch, not shown, to the driven unit.

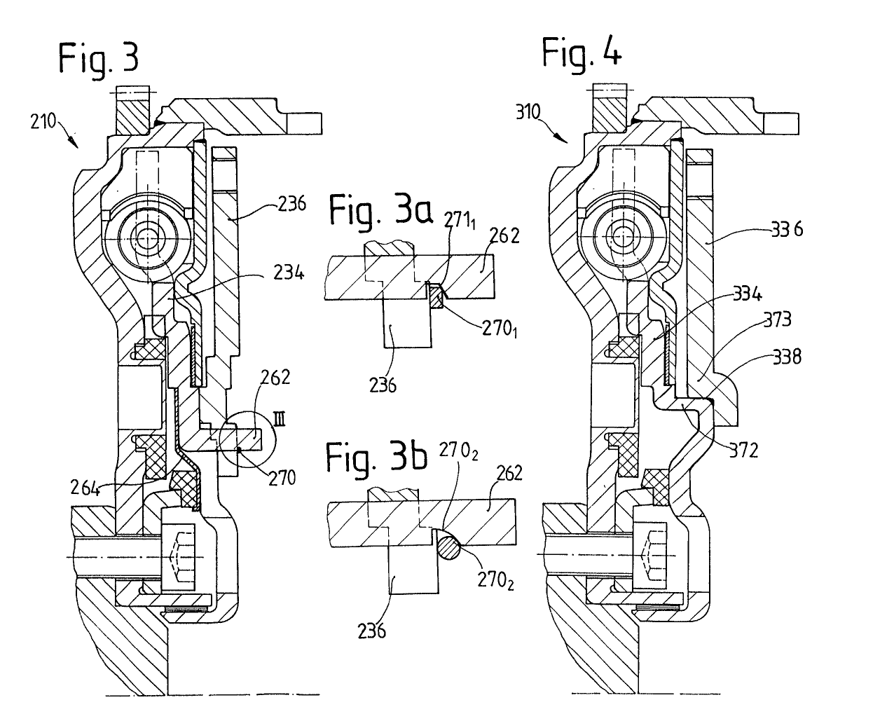

FIG. 3 shows another torsional vibration damper 210 according to the invention. With respect to its construction, this torsional vibration damper 210 also corresponds extensively to the torsional vibration damper 10 described in detail in FIG. 1; therefore, only the differences between them will be discussed in the following. In the torsional vibration damper 210, the flywheel mass element 236 is likewise coupled with the transmission part 234 via bearing tongues 262. However, axial securing is carried out by means of an additional retaining ring 270, and not by caulking.

As is shown in FIGS. 3a and 3b, which show an enlarged view of area III from FIG. 3, there are various arrangements possible for axial securing by means of a retaining ring. FIG. 3a shows a retaining ring 270₁ which is substantially rectangular in cross section and which engages in an associated notch 271₁. The construction shown in FIG. 3b comprises a retaining ring 270₂ which is substantially circular in cross section and which engages in a notch which is shaped like a quarter-circle in cross section. The bearing tongues 262 cooperate with corresponding recesses at the radial inner area of the flywheel mass element 236 in the manner of teeth for transmitting power in circumferential direction.

FIG. 4 shows another embodiment of a torsional vibration damper 310 according to the invention whose construction corresponds essentially to that of the torsional vibration damper 10 according to FIG. 1. Therefore, the same reference numbers are again used for the same components, but are increased by 300. The torsional vibration damper 310 according to FIG. 4 differs from the torsional vibration damper according to FIGS. 1, 2 and 3 only in that the flywheel mass element 336 is not connected with the transmission part 334 in a positive engagement, but is connected in an interference fit in connection area 338. The interference fit is produced in that the transmission part 334 has a positioning step 372 in the connection area 338 and the flywheel mass element has a corresponding positioning step 373. The connection between the flywheel mass element 336 and transmission part 334 is carried out in that the flywheel mass element 336 is shrink-fitted to the positioning step 372 of the transmission part 334 by its positioning step 373 and in that the flywheel mass element 336 and transmission part 334 are in mutual frictional engagement with one another after shrinking on.

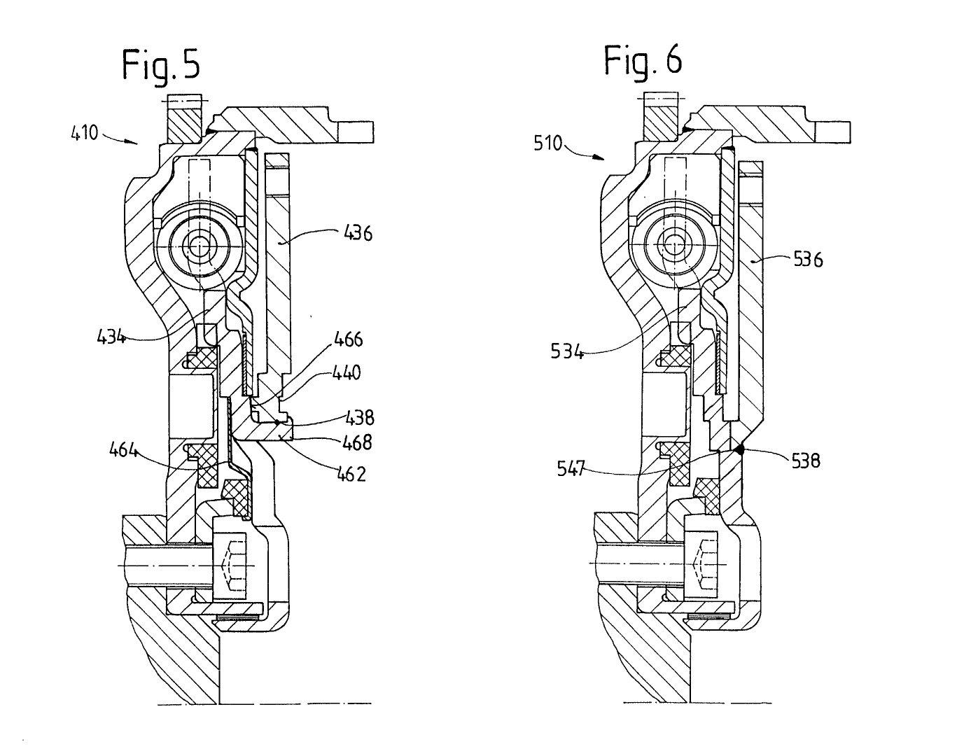

FIG. 5 shows another embodiment example of a torsional vibration damper 410 according to the invention, wherein identical components are designated by the same reference numbers as in the preceding Figures, but increased by 400. Again, the torsional vibration damper 410 differs from the torsional vibration dampers according to FIGS. 1 to 4 only with respect to the connection area 438. In the connection area 438, the flywheel mass element 436 is connected with the transmission part 434 via bearing tongues 462 which are caulked at their ends 468 remote of the primary side, so that the radial inner area 440 is pressed against the transmission part 434 via corresponding pressed out portions. In contrast to the embodiment form according to FIG. 2, however, no recesses are provided at the radial inner area 440 of the flywheel mass element 436, i.e., the flywheel mass element 436 does not engage with the bearing tongues 462 in a tooth-like manner. Transmission of torque from the transmission part 434 to the flywheel mass element 436 is accordingly carried out only via frictional engagement along the contact surface 466.

FIG. 6 shows another torsional vibration damper 510 according to the invention which again differs from the torsional vibration dampers according to FIGS. 1 to 5 only with respect to the construction of the connection area 538. Therefore, identical components are designated by the same reference numbers used above, but increased by 500.

In the torsional vibration damper according to FIG. 6, the flywheel mass element 536 is connected in a material engagement with the transmission part 534 in the connection area 538 by means of welding, especially by laser welding. For this purpose, the flywheel mass element 536 is first attached to the positioning step 547 and is subsequently welded in the area of the positioning step, i.e., in the connection area 538. The two parts 534 and 536 can also be connected with one another by soldering.

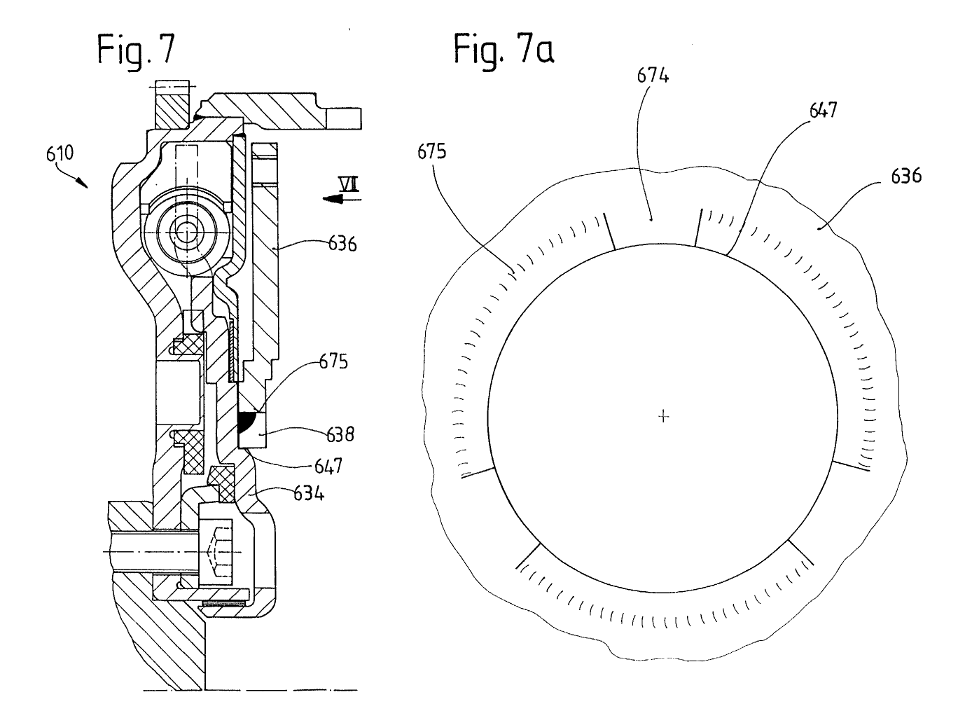

FIG. 7 shows another torsional vibration damper 610 according to the invention in which the same reference numbers as those in the preceding are used again, but are increased by 600. The torsional vibration damper 610 differs from the torsional vibration dampers described above only in the construction of the connection area 638. FIG. 7a serves to explain the design of the connection area 638. In its radial inner area, the flywheel mass element 636 of the torsional vibration damper 610 has three positioning tongues 674 which are fitted to the positioning step 647 for positioning the flywheel mass element 636 relative to the transmission part 634. The flywheel mass element 636 is then welded at its radial inner edge 675 to the transmission part 634 in circumferential direction between the positioning tongues 674.

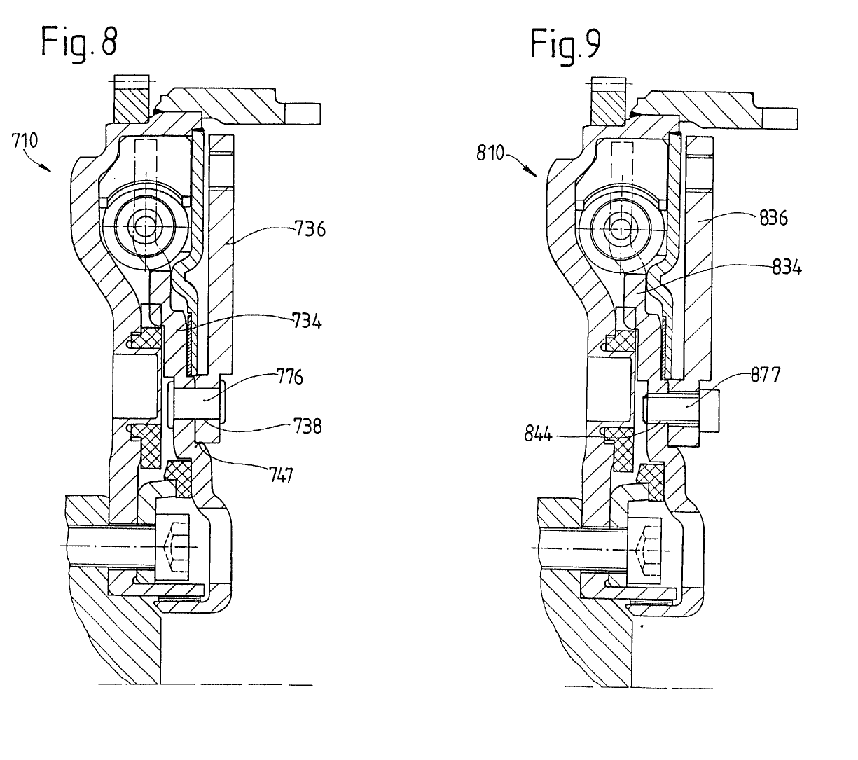

FIG. 8 shows another embodiment example of a torsional vibration damper 710 according to the invention in which the same reference numbers are again used as in the torsional vibration dampers according to FIGS. 1 to 7 described above, but increased by 700. The torsional vibration damper 710 differs from the torsional vibration dampers described above only in the construction of the connection area 738. In the torsional vibration damper 710, the flywheel mass element 736 and the transmission part 734 are fastened via a plurality of connection rivets 776 arranged in circumferential direction. A positioning of the flywheel mass element 736 relative to the transmission part 734 is carried out via the positioning step 747.

FIG. 9 shows another embodiment example of the torsional vibration damper 810 according to the invention. The torsional vibration damper 810 shown in FIG. 9 differs from the torsional vibration damper 710 shown in FIG. 8 only in that the flywheel mass element 836 is connected with the transmission part 834 via a connection screw 877, wherein the thread of the screw 877 engages in an associated internally threaded opening 844 at the transmission part 834.

All of the flywheel mass elements of the torsional vibration dampers shown in FIGS. 1 to 9 are produced from a sheet metal material.

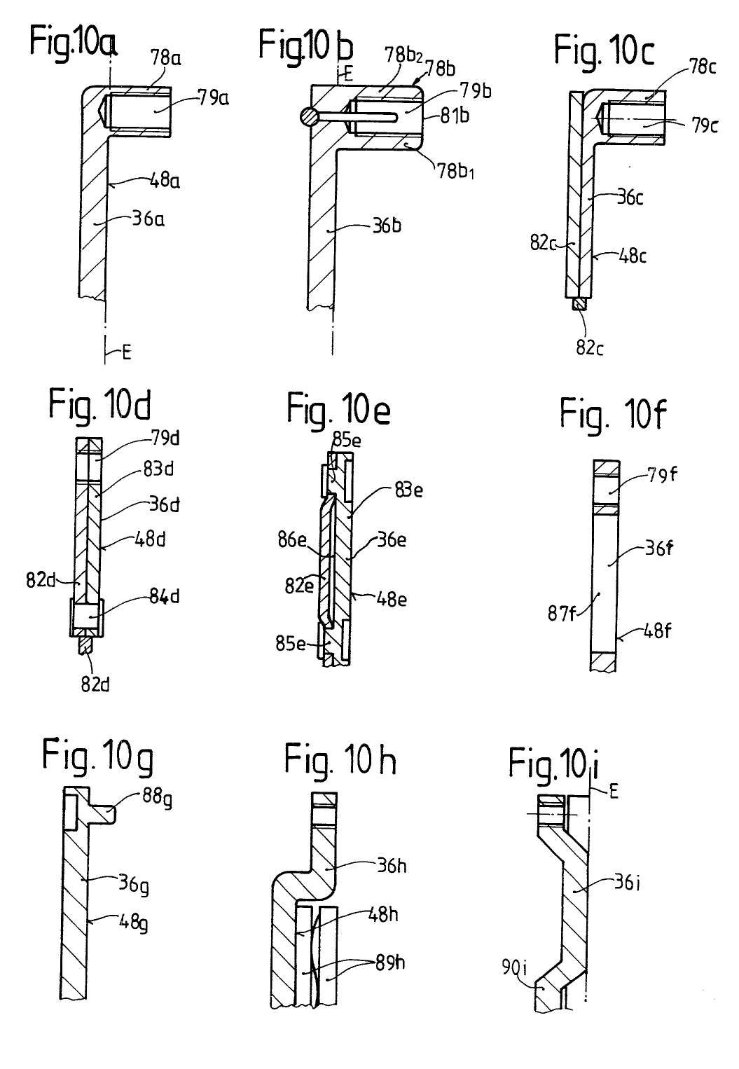

FIGS. 10a to 10i show various embodiment forms of the radial outer area and of the adjoining area of the friction surface of a flywheel mass element 36 such as can be used in all of the embodiment examples shown in FIGS. 1 to 9.

FIG. 10a shows a flywheel mass element 36a in partial sectional view which is bent in its radial outer area along the entire circumference orthogonal to the disk plane E defined by the friction surface 48a in the form of a circumferential bend 78a. A receiving opening 79a is introduced in the circumferential bend 78a and has an internal thread to which a thrust plate assembly, not shown, of a friction clutch can be fastened. A plurality of receiving openings 79a of this type can be provided in circumferential direction.

FIG. 10b shows a flywheel mass element 36b with a circumferential bend 78b which is constructed with two layers in that the sheet metal material of the flywheel mass element 36b is first bent orthogonal to the disk plane E in one direction corresponding to portion 78b₁ and is then bent back essentially 180° in a vertex area 79b with a portion 78b₂. The circumferential bend 78b is accordingly substantially U-shaped in cross section and forms a gap 80b. The gap 80b can be closed in circumferential direction at its opening by a weld, so that the two layers 78b₁ and 78b₂ are connected with one another in a material engagement on both sides in axial direction. A plurality of receiving openings 79b with an internal thread are arranged in the area of the vertex 81b so as to be distributed along the circumference for fastening to a thrust plate assembly, not shown.

The flywheel mass element 36c shown in FIG. 10c is constructed with double layers in its radial outer area in the area of the friction surface 48c. The right-hand side, with reference to FIG. 10c, corresponds essentially to the construction of the flywheel mass element according to FIG. 10a. On the side remote of the friction surface 48c, another sheet metal part 82c is arranged as a reinforcement. In the radial inner area, only the other sheet metal part 82c is guided further for fastening to the transmission part (not shown), wherein this other sheet metal part 82c is stepped in the direction of the sheet metal part 36c by deformation.

FIG. 10d shows another double-layered flywheel mass element 36d comprising a first sheet metal part 83d and another sheet metal part 82d which lie against one another along their surfaces in the radial outer area and in the area of the friction surface 48a and which are connected with one another in circumferential direction via rivets 84d. Again, the other sheet metal part 82d is continued toward the radial inner side while forming steps. Further, a plurality of receiving openings 79d are introduced in the two sheet metal parts in circumferential direction after the latter are joined and are provided with an internal thread for arranging a thrust plate assembly (not shown).

FIG. 10e shows another double-layered flywheel mass element 36e, wherein the sheet metal part having the friction surface 48e is provided with rivets 85 which are formed integral therewith and which engage in corresponding receiving openings in the other sheet metal part 82e and fixedly connect the sheet metal parts 83e and 82e with one another. In the area of the friction surface 48e, the other sheet metal part 82e is arranged at a distance from the sheet metal part 83e having the friction surface, so that an air gap 86e is formed which serves to cool the sheet metal part 83e which is highly loaded thermally in the area of the friction surface 48e.

FIG. 10f shows a flywheel mass element 36f which has, in its radial outer area, receiving openings 79f with an internal thread and which has narrow slits 87f (shown in section) extending from the radial inner side to the radial outer side. These slits which are arranged in a star-shaped manner provide for a cooling effect in the area of the friction surface 48f.

FIG. 10g shows a flywheel mass element 36g, wherein a plurality of positioning pins 88g are pressed out in the radial outer area of the flywheel mass element 36g proceeding from the side remote of the friction surface. The positioning pins 88g serve to position a thrust plate assembly, not shown, and, if required, can also be used for riveting as is shown in FIG. 10e in the opposite direction for the connection of the two sheet metal parts 82e and 83e.

FIG. 10h shows a flywheel mass element 36h which is constructed in a stepped manner above the friction surface 48h for reinforcement. Further, FIG. 10h shows clutch disks 89h of the friction clutch which has already been mentioned a number of times.

Finally, FIG. 10i shows a flywheel mass element 36i in which mounting tongues 90i project from the disk plane E for fastening the thrust plate assembly, not shown, on the radial outer side and for arranging the transmission part on the radial inner side. The fastening tongues 90i are given the shape shown in FIG. 10i by stamping and forming.

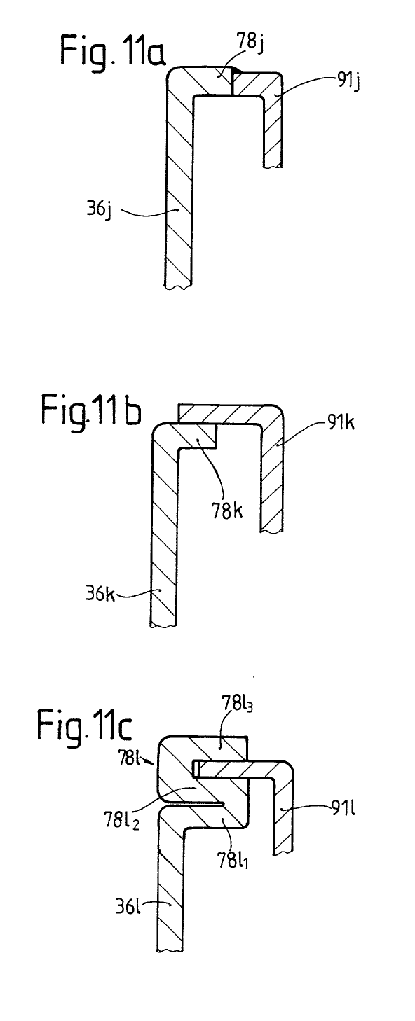

FIGS. 11a to 11c show possibilities for fastening a housing 91 of a thrust plate assembly, not shown, to the flywheel mass element 36 as alternatives to the fastening possibilities shown in FIGS. 10a- 10i. In FIG. 11a, the housing 91j is welded to the circumferential bend 78j or is soldered to it. In FIG. 11b, the housing 91k is shrink-fitted to the circumferential bend 78k. In FIG. 11c, the circumferential bend 781 is constructed in three layers with a first portion 781₁, a second portion 781₂ and a third portion 781₃, wherein the three portions extend in an S-shaped manner and the two portions 781₂ and 781₃ form a gap between them in which the housing 911 is clamped.

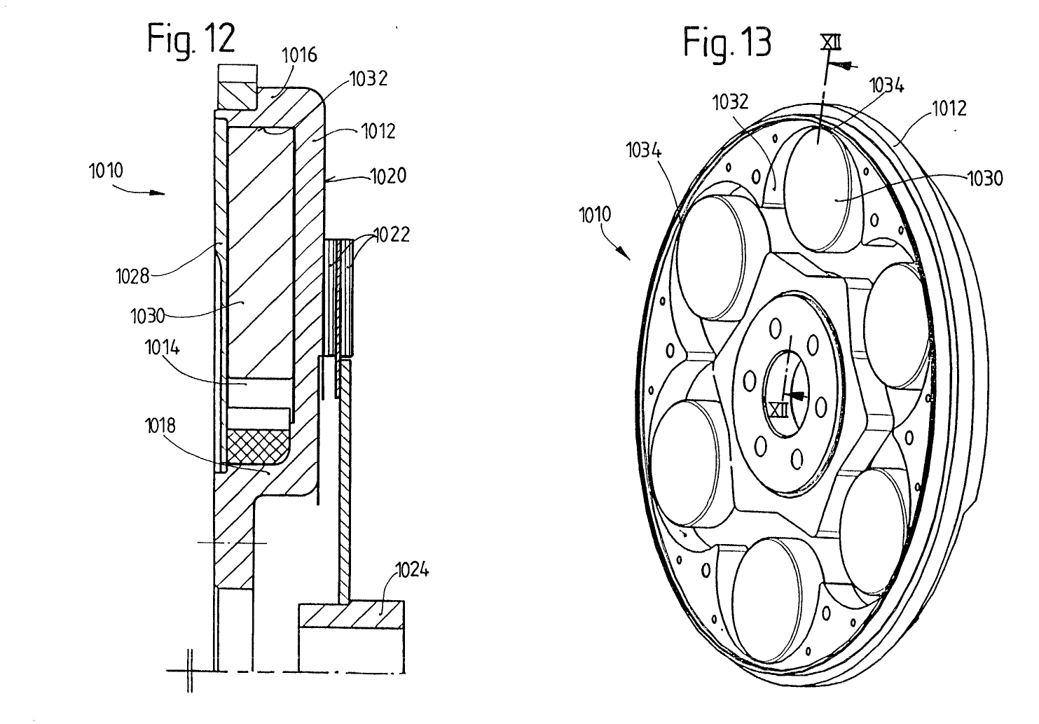

FIGS. 12 to 17 show other embodiment forms of a torsional vibration damper according to the present invention. In contrast to the torsional vibration damper according to FIGS. 1 to 9, this torsional vibration damper does not have a damper element arrangement comprising at least one spring unit, but rather is a torsional vibration damper with deflection masses. In the following, new reference numbers beginning with 1010 are used to describe the embodiment examples according to FIGS. 12 to 17 without reference to the embodiment examples described above or the reference numbers used for them.

The torsional vibration damper 1010 according to FIGS. 12 and 13 comprises a housing constructed as a flywheel mass element 1012. The flywheel mass element 1012 is constructed as a sheet metal part and is shaped in such a way that it defines bearing chambers 1014. For this purpose, the flywheel mass element 1012 has an axial portion extending substantially in axial direction in its radial outer area and an axial portion 1018 which extends substantially axially in its radial inner area and which is connected with the axial portion 1016 by a radial area defining a friction surface 1020. The friction surface 1020 cooperates with the clutch disks 1022 which are coupled with a driven shaft 1024 so as to be fixed with respect to rotation relative to it. As is indicated by the dash-dot line 1026, the flywheel mass element 1012 is connected with a drive unit, not shown, via fastening elements.

The bearing chambers 1014 are closed by a cover plate 1028. Deflection masses 1030 are received in the bearing chambers 1014 and can move in these bearing chambers 1014. The deflection masses 1030 are pressed against deflection paths 1032 formed in the radial outer area of the bearing chambers 1014 under the influence of centrifugal force, i.e., when the torsional vibration damper 1010 rotates about the axis of rotation A. The deflection paths 1032 are essentially arc-shaped, but have a greater diameter than the deflection masses 1030 which are shaped substantially in a circular-cylindrical manner, so that the deflection masses 1030 roll on the deflection paths 1032 by their cylindrical outer surface.

As was indicated above, the deflection masses 1030 are pressed against the deflection paths 1032 under the action of centrifugal force, wherein they swing into a vertex area 1034 at constant rotational speed. When there is a change in rotational speed, the deflection masses 1030, due to their inertia, move along the paths 1032 and accordingly radially inward opposite the action of centrifugal force, which leads to a torsional vibration damping effect.

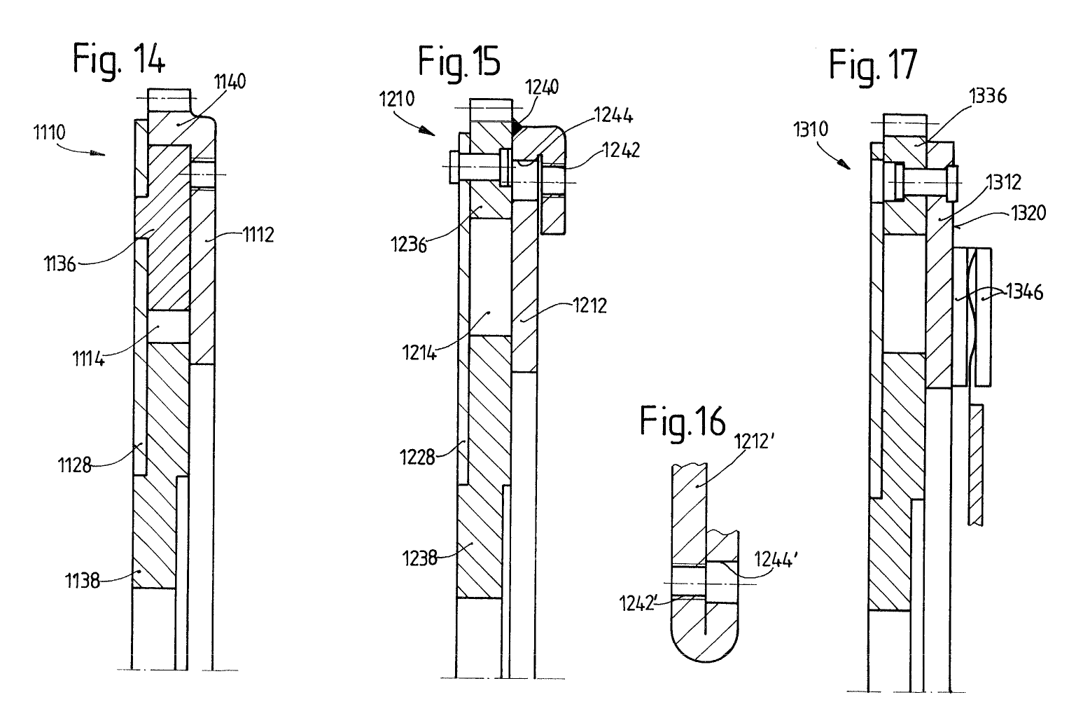

FIG. 14 shows a modification of the torsional vibration damper shown in FIGS. 12 and 13, wherein the same reference numbers are used for the description as in FIGS. 12 and 13, but increased by 100.

The flywheel mass element 1112 defines the bearing chambers 1114 in FIG. 14 only toward the right-hand side and radially outward. However, the deflection paths are not directly formed by the flywheel mass element 1112, but by inserts 1136 which are fixed by the cover plate 1128. Toward the radial inner side, the bearing chambers 1114 are defined by another insert 1138 which is coupled with a drive shaft, not shown. The starter ring gear 1140 is formed in the radial outer area at the flywheel mass element 1112.

The embodiment form according to FIG. 15 shows a torsional vibration damper 1210 which is described using reference numbers from the embodiment examples in FIGS. 12 to 14, but increased by 200. The flywheel mass element 1212 is constructed in a disk-shaped manner and is bent in a U-shaped manner in the radial outer area to increase the mass inertia. The inserts 1236 and 1238 which form the deflection path and define the bearing chambers 1214 on the radial inner side are connected with one another by the sheet metal part 1228 and are welded in the radial outer area at 1240 with the flywheel mass element 1212. A receiving opening 1242 with an internal thread which is flush with an opening 1244 having a larger diameter is provided in the radial outer area. The receiving opening 1242 serves to receive a screw for fastening a thrust plate assembly, not shown. FIG. 16 shows an alternative construction of the U-shaped bend in the radial outer area in which the receiving bore hole 1244′ having the greater diameter is penetrated by a fastening screw of the thrust plate assembly which then first engages the thread of the fastening bore hole 1242′.

FIG. 17 shows a simplified construction of a torsional vibration damper 1310 according to the invention similar to that shown in FIG. 15 in which the flywheel mass element 1312 is constructed in a disk-shaped manner and is riveted with the inserts 1336. Further, FIG. 17 shows clutch disks 1346 which engage with the flywheel mass element 1312 in the area of the friction surface 1320.

The flywheel mass element shown in FIGS. 12 to 17 and described with reference to these Figures is likewise produced from sheet metal material which can be shaped in an economical manner in technical respects relating to manufacture and can be hardened if necessary.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

We claim:

1. A torsional vibration damper, comprising:
a substantially disk-shaped flywheel mass element having an axis of rotation and a friction surface for cooperating with friction facings of a clutch, said flywheel mass element being produced from a sheet metal material; and
a damper element arrangement communicating with the flywheel mass element.

2. A torsional vibration damper as in claim 1 wherein the sheet metal material is one of STW 24 and aluminum.

3. A torsional vibration damper as in claim 1 further comprising a transmission part which cooperates with the damper element arrangement and which is connected to the flywheel mass element via a connection area so that the transmission part is fixed against rotation relative to said flywheel mass element.

4. A torsional vibration damper as in claim 3 wherein the flywheel mass element comprises positioning means and the transmission part comprises counter-positioning means, said positioning means cooperating with said counter-positioning means to position said flywheel radially relative to said transmission part.

5. A torsional vibration damper as in claim 3 wherein the flywheel mass element and the transmission part are positively engaged.

6. A torsional vibration damper as in claim 5 further comprising
one of a bolt and a rivet formed integrally with one of the flywheel mass element and the transmission part in the connection area, and
a receiving opening in the other of the flywheel mass element and the transmission part, said one of said bolt and said rivet being engaged in said receiving opening.

7. A torsional vibration damper as in claim 5 further comprising
teeth formed integrally with one of the flywheel mass element and the transmission part in the connection area, and
complementary teeth formed integrally with the other of the flywheel mass element and the transmission part, said teeth engaging said complementary teeth to fix said flywheel mass element against rotation relative to said transmission part.

8. A torsional vibration damper as in claim 7 wherein said flywheel mass element and said transmission part are caulked together in the connection area for axial securing.

9. A torsional vibration damper as in claim 7 further comprising a retaining ring which axially secures said flywheel mass element to said transmission part.

10. A torsional vibration damper as in claim 3 wherein said flywheel mass element and said transmission part are connected in an interference fit in the connection area.

11. A torsional vibration damper as in claim 10 wherein said flywheel mass element and said transmission part are caulked together in the connection area.

12. A torsional vibration damper as in claim 10 wherein said flywheel mass element comprises a positioning step having one of an inward facing and an outward facing cylindrical surface, and said transmission part comprises a counter-positioning step having the other of an inward facing and an outward facing cylindrical surface, said inward facing cylindrical surface being shrink-fitted onto the outward facing cylindrical surface to produce said interference fit.

13. A torsional vibration damper as in claim 3 wherein said flywheel mass element and said transmission part are materially engaged in the connection area.

14. A torsional vibration damper as in claim 13 wherein said flywheel mass element and said transmission part are welded together in said connection area.

15. A torsional vibration damper as in claim 13 wherein said flywheel mass element and said transmission part are glued together in said connection area.

16. A torsional vibration damper as in claim 3 further comprising at least one discrete connecting element connecting said flywheel mass element to said transmission element.

17. A torsional vibration damper as in claim 16 wherein said discrete connecting element is one of a screw and a rivet.

18. A torsional vibration damper as in claim 1 wherein said flywheel mass element is formed with a circumferential bend extending orthogonally to a plane formed by the friction surface.

19. A torsional vibration damper as in claim 18 wherein said circumferential bend is provided with at least one axially extending fastening opening having internal threads for fastening a thrust plate assembly of the friction clutch.

20. A torsional vibration damper as in claim 18 wherein said circumferential bend comprises two coaxial layers of said sheet metal material, said circumferential bend having a vertex area where said sheet metal material is bent back on itself.

21. A torsional vibration damper as in claim 18 wherein said circumferential bend comprises two layers having a clamping gap therebetween for clamping a thrust plate assembly of the friction clutch.

22. A torsional vibration damper as in claim 1 wherein said flywheel mass element has an outer radial area which is provided with at least one of a positioning pin and a fastening rivet for fastening a thrust plate assembly of the friction clutch.

23. A torsional vibration damper as in claim 1 wherein said flywheel mass element comprises radially extending cooling slits in the friction surface.

24. A torsional vibration damper as in claim 1 wherein said flywheel mass element has an outer radial area which is formed with a step.

25. A torsional vibration damper as in claim 1 wherein said flywheel mass element comprises two sheet metal parts adjacent to the friction surface.

26. A torsional vibration damper as in claim 25 wherein said sheet metal parts are connected by one of screws, rivets, and glue.

27. A torsional vibration damper as in claim 25 wherein the sheet metal parts are spaced apart adjacent to the friction surface.

28. A torsional vibration damper as in claim 33 wherein the flywheel mass element is formed with mounting tongues for at least one of fitting a thrust plate assembly of the friction clutch and positioning the transmission part.

29. A torsional vibration damper as in claim 28 wherein the mounting tongues are formed upward from a plane formed by the flywheel mass element.

30. A torsional vibration damper as in claim 3 wherein said transmission part is a second transmission part, said torsional vibration damper further comprising a first transmission part which can be connected to a drive unit, said damper element arrangement having at least one spring element which is arranged in the torque flow between the first transmission part and the second transmission part.

31. A torsional vibration damper as in claim 30 further comprising at least one planet wheel journeled to one of said first and second transmission parts for rotation about an axis parallel to said axis of rotation of said flywheel, said plane wheel engaging the other of said first and second transmission parts and rotating about its axis as said first transmission part rotates relative to said second transmission art.

32. A torsional vibration damper as in claim 31 wherein said first transmission part has a bearing on which said plant wheel is journeled.

33. A torsional vibration damper as in claim 1 wherein said damper element arrangement comprises at least one deflection mass which is movable along a deflection path abut the axis of rotation during rotation of the flywheel mass element.

34. A torsional vibration damper as in claim 33 wherein said deflection path has a vertex area flanked by deflection areas whose radial distance from the axis of rotation decreases with increasing distance from the vertex area.

35. A torsional vibration damper as claim 33 wherein said flywheel mass element at least partially defines at least one bearing chamber in which said at least one deflection mass is received.

36. A torsional vibration damper as in claim 35 wherein said bearing chamber defines said deflection path.

37. A torsional vibration damper as in claim 35 further comprising a cover element which is fitted to said flywheel mass element to define said bearing chamber.
